(19) United States
(12) Patent Application Publication
(10) Pub. No.: US 2009/0058012 A1
(43) Pub. Date: Mar. 5, 2009

(54) SEAL FOR A ROTATING LASER TRANSMITTER

(76) Inventor: Trent Edward Walters, Tipp City, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/848,481

(22) Filed: Aug. 31, 2007

(51) Int. Cl. F16J 15/16

(52) U.S. Cl. 277/391

(57) ABSTRACT

A laser transmitter, includes a transmitter case defining an opening therein, and a laser generating unit extending from said opening in said transmitter case. The laser generating unit has a non-rotatable portion and a rotatable laser head. The rotatable laser head is rotatable around a rotation axis. A flexible bellows seal surrounds the laser generating unit in said opening. The flexible bellows seal extending from the edge of the opening to the non-rotatable portion of the laser generating unit and defines a plurality of annular pleats. The pleats are spaced generally in the direction of the rotation axis of said rotatable laser head. This transmitter seals out dirt and water and eliminates the opportunity for dirt and water to collect on the seal.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

The present invention relates to laser transmitters of the type that are useful for surveying or spatial positioning at a construction site or elsewhere in all sorts of inclement weather. Laser transmitters of the type that project a thin beam of laser light or a fan-shaped beam of laser light, and rotate the beam about a rotation axis have been in use for a number of years at construction sites. Such transmitters can be used in manual surveying systems and in automated surveying systems. Such transmitters can also be used in spatial positioning systems of the type that provide for control of earthmoving machines, and the like, to shape a construction site to a desired contour. It will be appreciated that transmitters of this type are frequently subjected to harsh operating conditions. Dust and moisture are both encountered constantly, but it is necessary to keep the transmitter case and the transmitter components as free of dust and moisture contamination as possible so that the transmitter can function properly.

One type of prior art seal arrangement for a laser transmitter is shown in FIG. 1, which depicts a portion of the transmitter 10 with the seal and other elements in cross-section and with other parts of the transmitter broken away. The transmitter 10 has a transmitter case 12, a laser generating unit 14 having a non-rotatable portion 16 and a rotatable laser head 18. Rotatable laser head 18 includes a pentaprism element 20 which redirects a laser beam that is generated by a laser source in the casing 12 and that passes upward through shaft 21. The beam is directed radially outward through an opening in cover 22 by the pentaprism 20. The beam is swept around an axis of rotation defined by shaft 21 as the laser head 18, including pentaprism 20 and cover 22, is rotated. The rotatable laser head 18 includes a support element 24 that rides on bearings 26 and that is driven by an electric motor 28.

The laser generating unit 14 extends out of an opening 30 in the transmitter case 12. A seal 32 is provided in the opening 30, surrounding the laser generating unit 14 to seal the opening between the case 12 and the non-rotatable portion 16 of the laser generating unit 14. The seal 32 defines series of convolutions that are arranged in concentric rings. These convolutions make the seal 32 very flexible, allowing the laser generating unit to be tilted with respect to the transmitter case 12 while continuing to seal opening 30. One difficulty encountered with this sealing arrangement is that transmitters used at construction sites are exposed to the elements, and this sealing arrangement results in dirt and water collecting on the top of the transmitter in the grooves defined by the seal convolutions. It will be appreciated that this will make it more difficult for the transmitter operator to use the transmitter, as frequent cleaning may be required. Further, allowing water to collect on the seal 32 for extended periods of time may cause deterioration of the seal itself.

It is seen, therefore, that there is a need for a laser transmitter of the type in which a rotatable laser head extends from the transmitter case and in which sealing around the laser generating unit does not result in the collection of dirt and water.

### SUMMARY OF THE INVENTION

This need is met by a laser transmitter according to the present invention having a transmitter case with an opening therein, a laser generating unit extending from the opening in the transmitter case, and a flexible bellows seal surrounding the laser generating unit in the opening. The laser generating unit has a non-rotatable portion and a rotatable laser head. The rotatable laser head is rotatable around a rotation axis. The flexible bellows seal extends from the edge of the opening to the non-rotatable portion of the laser generating unit and defines a plurality of annular pleats. The pleats are spaced generally in the direction of the rotation axis of the rotatable laser head. As a consequence, the seal between the case and the laser generating unit is maintained when said laser generating unit is tilted with respect to said case.

The flexible bellows seal may be made of an elastomer material, such as a silicone rubber. The pleats of the flexible bellows seal preferably define a plurality of annular convolutions configured such that they do not collect water. One annular edge of the flexible bellows seal is received in an annular groove in the case surrounding the opening. A retaining ring preferably surrounds the annular groove so as to maintain the annular edge of the flexible bellows seal in the annular groove. The other annular edge of the flexible bellows seal is received within an annular groove on the non-rotatable portion of the laser generating unit.

The pleats of the flexible seal may define one or more annular convolutions that are configured not to collect water. The pleats in the flexible seal may be spaced apart generally in the direction of the rotation axis of the rotatable laser head. By this arrangement, the seal between the case and the laser generating unit is maintained when the laser generating unit is tilted with respect to the case.

The flexible bellows seal preferably defines at least one annular pleat. The pleat faces outward from the rotation axis of the rotatable laser head such that the pleat does not define a recess in which water would collect, regardless of whether the rotation axis is generally vertical or generally horizontal. By this arrangement, the seal between the case and the laser generating unit is maintained when the laser generating unit is tilted with respect to the case.

Accordingly, it is an object of the present invention to provide a laser transmitter in which a flexible seal surrounds the laser generating unit that extends from an opening in the transmitter casing, in which the flexible seal extends from the edge of the opening to the non-rotatable portion of the laser generating unit, and in which the flexible seal defines at least one pleat to permit the laser generating unit to be tilted with respect to the case while maintaining the seal between the laser generating unit and the transmitter case.

### BRIEF DESCRIPTION OF THE DRAWINGS

FIG. 1 is a sectional view, with portions broken away, of a prior art transmitter design;

FIG. 2A is a plan view of a flexible bellows seal according to the present invention;

FIG. 2B is a sectional view, taken generally along line A-A in FIG. 2A, of the flexible bellows seal;

FIG. 2C is a perspective view of a flexible bellows seal according to the present invention;

FIG. 3 is a perspective view of a laser transmitter according to the present invention;

FIG. 4 is a perspective view of the laser transmitter of FIG. 3 with a part of the transmitter case removed;

FIG. 5 is a perspective view of the laser transmitter of FIG. 3 with a part of the transmitter case removed and with parts of the rotatable laser head exploded;

FIG. 6 is a sectional view of the laser transmitter taken through the rotatable laser head; and

FIG. 7 is an enlarged partial sectional view of the laser transmitter, taken along the same line as FIG. 6.

### DETAILED DESCRIPTION OF THE PREFERRED EMBODIMENTS

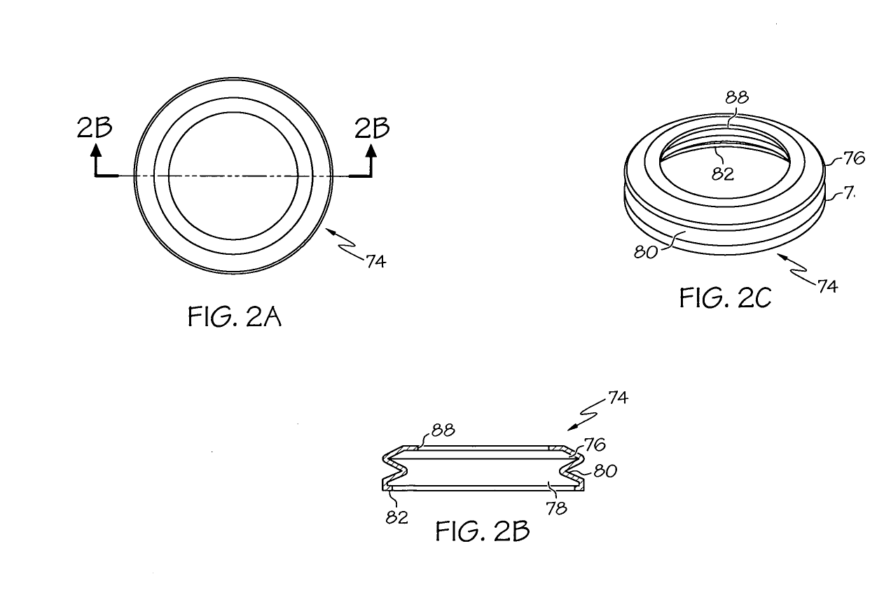

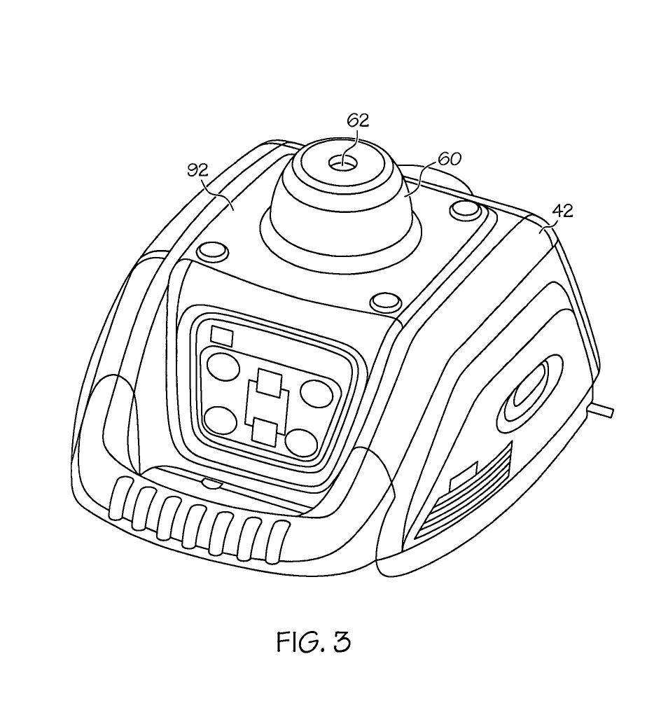

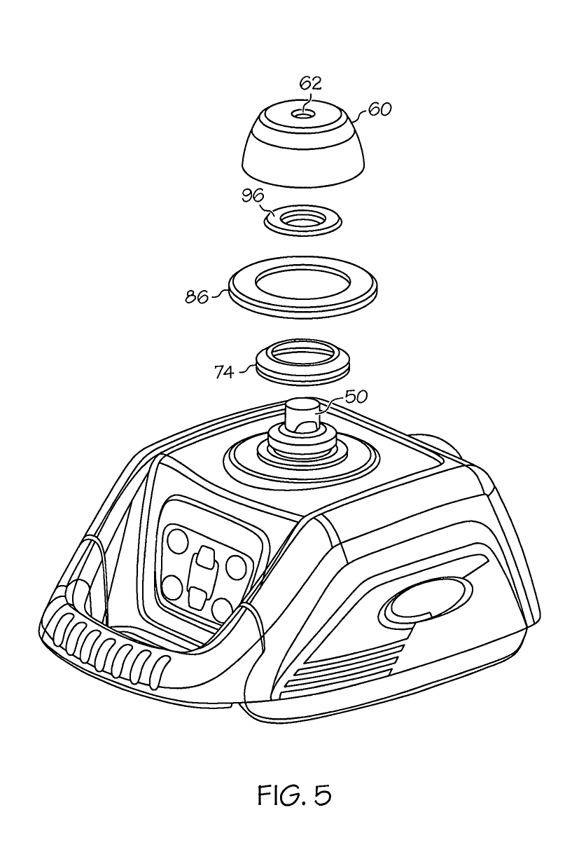

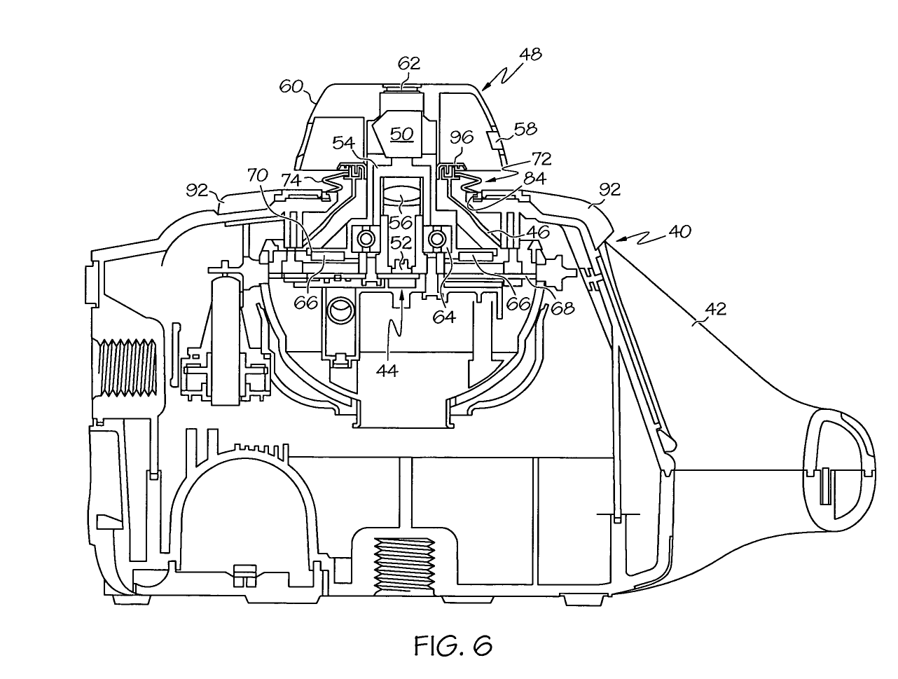

Reference is made to FIGS. 2 through 7 which illustrate a laser transmitter 40 constructed according to the present invention. As seen in FIG. 6, the laser transmitter 40 has a transmitter case 42, and a laser generating unit 44 having a non-rotatable portion 46 and a rotatable laser head 48. Rotatable laser head 48 includes a pentaprism element 50 which redirects a laser beam that is generated by a laser diode 52 and that passes upward through shaft 54 and lens 56. The beam is directed radially outward through an opening 58 in cover 60 by the pentaprism 50, and is swept around an axis of rotation defined by shaft 54. A portion of the beam may also pass upward through the pentaprim 50 and pass out of the cover 60 through opening 62.

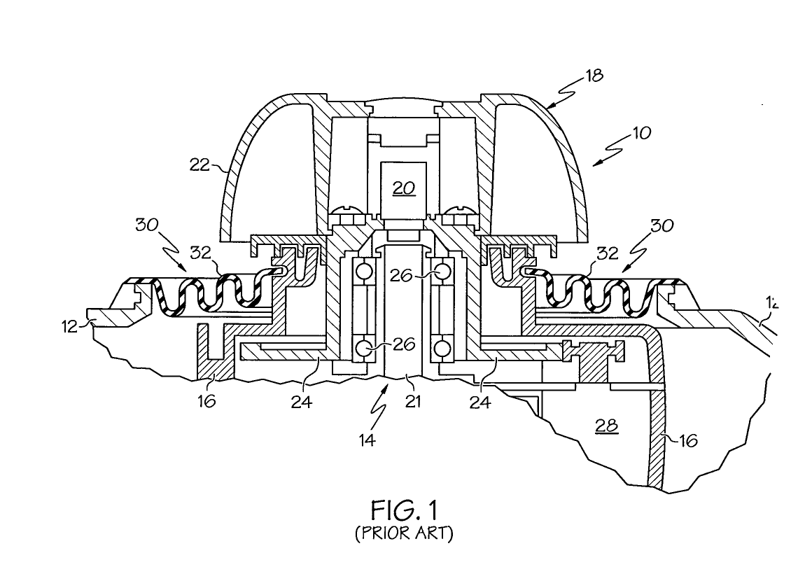

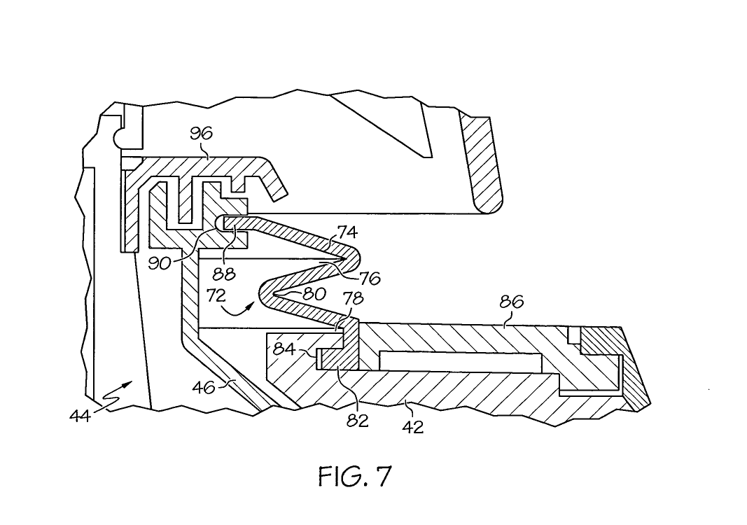

The rotatable laser head 48 rides on bearings 64 and is driven by an electric motor 66 that includes permanent magnets 66 on support 70 and stator motor coils, not shown, located on circuit board 68. The laser generating unit 44 extends out of an opening 72 in the transmitter case 42. As seen in FIGS. 6 and 7, flexible bellows seal 74 is provided in the opening 72, surrounding the laser generating unit 44 and sealing the opening between the case 42 and the non-rotatable portion 46 of the laser generating unit 44. The flexible bellows seal 74, shown by itself in FIGS. 2A, 2B, and 2C, extends from the edge of the opening 72 to the non-rotatable portion 46 of the laser generating unit 44 and defines a plurality of annular accordian pleats 76, and 78. The pleats 76 and 78 are spaced from each other generally in the direction of the rotation axis of the rotatable laser head 48, whereby the seal between the case 42 and the laser generating unit 44 is maintained when the laser generating unit 44 is tilted with respect to the case 42. The flexible bellows seal may be made of an elastomer material, such as a silicone rubber. The silicone rubber is preferably a 35±5 durometer Shore A material. The pleats 76 and 78 of the flexible bellows seal 74 define one or more annular convolutions 80 that are configured so that they do not collect water, regardless of the orientation of the laser transmitter. It should be noted that while only two pleats 76 and 78, and a single convolution 80 between the pleats, are shown in the drawings, a greater number of pleats and intermediate convolutions may be provided in the seal 74, depending upon the size of the opening 72 in the casing and the position of the laser generating unit 44 in the opening 72. In addition to eliminating the problem of water collecting in the seal, the convolutions on the outside of the sea 74 are such that it is also unlikely that a significant amount of dirt and debris will collect in the convolutions. By this arrangement, a number of the problems encountered with prior art seals, such as seal 30 in FIG. 1, are eliminated.

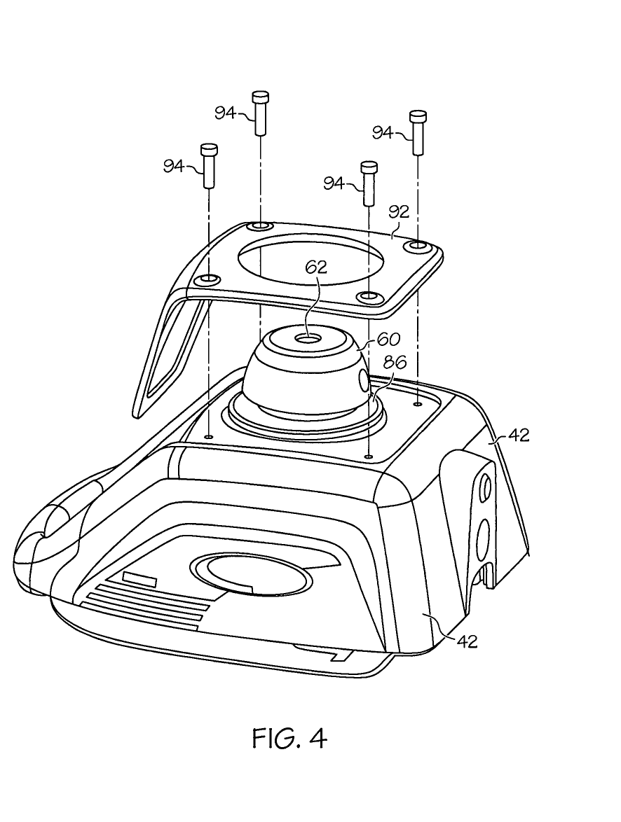

As seen in FIGS. 6 and 7, one annular edge 82 of the flexible bellows seal 74 is received in an annular groove 84 in the case surrounding the opening 72. A retaining ring 86 surrounds the annular groove 84 to maintain the annular edge 82 of the flexible bellows seal 74 in the annular groove 84. The other annular edge 88 of the flexible bellows seal 74 is received within an annular groove 90 on the non-rotatable portion 46 of the laser generating unit. As shown in FIGS. 4, 6 and 7, the retaining ring 86 is held in position by an upper housing cover 92 which is secured to the case 42 with screws 94.

The rotatable laser head includes a seal plate 96 which together with the non-rotatable portion 46 of the laser generating unit 44 defines a serpentine path from the exterior of the transmitter to the interior of the transmitter case 42. Because seal plate 96 and non-rotatable portion 46 do not touch, there is no friction loss. However, due to the narrow serpentine path between seal plate 96 and non-rotation portion 46, the interior of the case 12 is kept free of a significant amount of dust.

It will be appreciated that the seal of the present invention is advantageous in that it is of a smaller diameter than the diameters of prior art seals of the type shown in FIG. 1. Because the seal 74 constructed according to the present invention has pleats and convolutions that are spaced vertically (i.e., in the direction of the axis of rotation of rotatable laser head 48), the seal 74 has a compact size that permits it to be shielded by cover 60 quite effectively. Note particularly that the prior art seal 32 of FIG. 1 extends significantly beyond the cover 22, exposing the seal 32 to possible damage during use. This is a result of the horizontal spacing of the convolutions in the prior art seal. The present invention overcomes this disadvantage.

Other aspects, objects, and advantages of the present invention can be obtained from a study of the drawings, the disclosure, and the appended claims.

What is claimed is:

1. A laser transmitter, comprising:
a transmitter case defining an opening therein,
a laser generating unit having a non-rotatable portion and a rotatable laser head, said rotatable laser head being rotatable around a rotation axis, the laser generating unit extending from said opening in said transmitter case, and
a flexible bellows seal surrounding said laser generating unit in said opening, said flexible bellows seal extending from the edge of said opening to said non-rotatable portion of said laser generating unit and defining a plurality of annular pleats, said pleats being spaced generally in the direction of the rotation axis of said rotatable laser head, whereby the seal between said case and said laser generating unit is maintained when said laser generating unit is tilted with respect to said case.

2. The laser transmitter of claim 1, in which said flexible bellows seal is made of an elastomer material.

3. The laser transmitter of claim 2, in which said flexible bellows seal is made of silicon rubber.

4. The laser transmitter of claim 1, in which said pleats of said flexible bellows seal defines one or more annular convolutions, configured such that they do not collect water.

5. The laser transmitter of claim 1 in which one annular edge of said flexible bellows seal is received in an annular groove in said case surrounding said opening.

6. The laser transmitter of claim 5 further comprising a retaining ring surrounding said annular groove so as to maintain said annular edge of said flexible bellows seal in said annular groove.

7. The laser transmitter of claim 6 in which the other annular edge of said flexible bellows seal is received within an annular groove on said non-rotatable portion of said laser generating unit.

8. A laser transmitter, comprising:
a transmitter case defining an opening therein,
a laser generating unit having a non-rotatable portion and a rotatable laser head, said rotatable laser head being rotatable around a rotation axis, the laser generating unit extending from said opening in said transmitter case, and
a flexible seal surrounding said laser generating unit in said opening, said flexible seal extending from the edge of said opening to said non-rotatable portion of said laser generating unit and defining a plurality of accordion pleats, said pleats being spaced apart generally in the direction of the rotation axis of said rotatable laser head, whereby the seal between said case and said laser generating unit is maintained when said laser generating unit is tilted with respect to said case.

9. The laser transmitter of claim 8, in which said flexible seal is made of an elastomer material.

10. The laser transmitter of claim 8, in which said pleats of said flexible seal define a plurality of annular convolutions configured not to collect water.

11. The laser transmitter of claim 8 in which one annular edge of said flexible seal is received in an annular groove in said case surrounding said opening.

12. The laser transmitter of claim 11 further comprising a retaining ring surrounding said annular groove so as to maintain said annular edge of said flexible seal therein.

13. The laser transmitter of claim 12 in which the other annular edge of said flexible seal is received within an annular groove on said non-rotatable portion of said laser generating unit.

14. The laser transmitter of claim 8 in which said flexible seal does not define collection pockets or recesses where water can accumulate.

15. The laser transmitter of claim 8 in which said flexible seal is made of silicone rubber.

16. A laser transmitter, comprising:
a transmitter case defining an opening therein,
a laser generating unit having a non-rotatable portion and a rotatable laser head for projecting a beam of laser light, said rotatable laser head being rotatable around a rotation axis, the rotatable laser head and a part of said non-rotatable portion extending from said opening in said transmitter case, and
a flexible seal having accordion pleats spaced generally in the direction of the extension of the rotatable laser head from said opening, said flexible seal surrounding said laser generating unit in said opening and extending from the edge of said opening to said non-rotatable portion of said laser generating unit, whereby said flexible seal seals the opening between said case and said laser generating unit and maintain the seal when said laser generating unit is tilted with respect to said case.

17. The laser transmitter of claim 16, in which said flexible seal is made of an elastomer material.

18. The laser transmitter of claim 16, in which said pleats of said flexible seal define a plurality of annular convolutions configured not to collect water.

19. The laser transmitter of claim 16 in which one annular edge of said flexible seal is received in an annular groove in said case surrounding said opening.

20. The laser transmitter of claim 16 further comprising a retaining ring surrounding said annular groove so as to maintain said annular edge of said flexible seal therein.

21. The laser transmitter of claim 20 in which the other annular edge of said flexible seal is received within an annular groove on said non-rotatable portion of said laser generating unit.

22. The laser transmitter of claim 16 in which said flexible seal does not define collection pockets or recesses where water can accumulate.

23. The laser transmitter of claim 16 in which said flexible seal is made of silicone rubber.

24. A laser transmitter, comprising:
a transmitter case defining an opening therein,
a laser generating unit having a non-rotatable portion and a rotatable laser head, said rotatable laser head being rotatable around a rotation axis, the laser generating unit extending from said opening in said transmitter case, and
a flexible bellows seal surrounding said laser generating unit in said opening, said flexible seal extending from the edge of said opening to said non-rotatable portion of said laser generating unit and defining at least one annular pleat, said pleat facing outward from said rotation axis such that said pleat does not define a recess in which water would collect regardless of whether said rotation axis is generally vertical or generally horizontal, whereby the seal between said case and said laser generating unit is maintained when said laser generating unit is tilted with respect to said case.
